(19) United States
(12) Patent Application Publication
(10) Pub. No.: US 2015/0008865 A1
(43) Pub. Date: Jan. 8, 2015

(54) SOLAR POWER CONVERTER AND METHOD OF CONTROLLING SOLAR POWER CONVERSION

(71) Applicant: KONINKLIJKE PHILIPS N.V., EINDHOVEN (NL)

(72) Inventors: Hongbo Wang, Shanghai (CN); Jianlin Xu, Shanghai (CN); Zhiquan Chen, Shanghai (CN); Zhenhua Zhou, Shanghai (CN)

(21) Appl. No.: 14/371,204

(22) PCT Filed: Jan. 4, 2013
(86) PCT No.: PCT/IB2013/050093

§ 371 Date: Jul. 9, 2014

Related U.S. Application Data
(60) Provisional application No. 61/585,266, filed on Jan. 11, 2012.

(51) Int. Cl. H02J 3/38; H05B 33/08; H02M 3/04; H02J 7/35

(52) U.S. Cl. CPC H02J 3/385; H02J 7/35; H05B 33/0815; H05B 33/0896; H02M 3/04
USPC 320/101; 323/234; 315/308

(57) ABSTRACT

A controller (306) executes a method (400) of controlling a solar power converter (20, 300) connected to receive output power from a solar power source (10). The method comprises: measuring (430) an open circuit voltage (VOC) of the solar power source; determining a short circuit current (ISC) output by the solar power source; using (440) the measured open circuit voltage (VOC) and the measured short circuit current (ISC) to determine an estimate of a voltage maximum power point (VMPP) for the solar power source corresponding to a maximum power point (MPP) for transferring the output power from the solar power source to a load; executing (450) a perturb-and-observe algorithm (500) beginning at the estimated VMPP to determine an actual VMPP for transferring the output power from the solar power source to the load; and operating (470) the solar power converter at or approximately at the actual VMPP.

### TECHNICAL FIELD

The present invention is directed generally to a solar power converter and a method of controlling solar power conversion. More particularly, various inventive methods and apparatus disclosed herein relate to an apparatus and method for maximizing power conversion from a solar power generating device.

### BACKGROUND

Solar power sources are being used for a variety of applications. As the cost of traditional fossil fuel power sources increases and as these sources become less favored due to environmental impacts, the use of solar power sources continues to expand.

Solar power systems employing solar panels, energy transfer device, energy storage device, are becoming widely used in land power systems, including on-grid and off-grid solar systems. In a solar power generating system, solar panels are used to generate electricity by the photovoltaic effect. Solar radiation is the input of the solar system, and an energy storage device, such as one or more batteries, is the output of the solar system. One advantage of a solar power system is that it is independent from any electrical distribution network and can be used in both fixed and mobile equipment.

In general, the output power from a solar power source has a characteristic curve wherein the output power reaches a maximum power, defined herein as the Maximum Power Point (MPP), at a certain output voltage, defined herein as the Voltage Maximum Power Point (VMPP). Transferring power from the solar power source at any other point than the MPP will be less efficient than operating at the MPP.

However, in general, the MPP for a solar power source will vary from one solar power source to another. Furthermore, the MPP for a given solar power source will vary with time, in particular due to changing environmental conditions, and specifically as the amount of solar energy received by the solar power source changes due to changes in the amount of sunlight that is received.

Thus, it would be desirable to provide a method and apparatus which can provide maximum power transfer from a power source which has a variable output power, such as a solar power source. It would further be beneficial to provide such a method and apparatus which can relatively rapidly and accurately converge on the maximum power point without employing a complicated algorithm.

### SUMMARY

The present disclosure is directed to inventive methods and apparatus for a solar power converter and a method of operating a solar power converter. For example, in some embodiments a solar power converter employs a maximum power point tracking algorithm which employs an initial estimate of the maximum power point from an open circuit voltage and a short circuit current of the solar power source.

Generally, in one aspect, a method is provided for controlling a solar power converter connected to receive output power from a solar power source. The method includes: measuring an open circuit voltage (VOC) of the solar power source; applying a short circuit across an output of the solar power source; determining a short circuit current (ISC) output by the solar power source while the short circuit is applied across the output of the solar power source; removing the short circuit from across the output of the solar power source; using the measured open circuit voltage (VOC) and the measured short circuit current (ISC) to determine an initial estimate of a voltage maximum power point (VMPP) for the solar power source corresponding to a maximum power point (MPP) for transferring the output power from the solar power source to a load; executing a perturb-and-observe algorithm beginning at the estimated VMPP to determine an actual VMPP for transferring the output power from the solar power source to the load; and operating the solar power converter at or approximately at the actual VMPP.

In one or more embodiments, the method further includes repeating the measuring, applying, determining, removing, using, and executing steps to update the actual VMPP as environmental conditions change resulting in changes to the actual VMPP.

In one or more embodiments, the method further includes periodically repeating the measuring, applying, determining, removing, using, and executing steps to periodically update the actual VMPP.

In one or more embodiments, using the measured VOC and the measured ISC to determine the estimated VMPP includes solving parametric equations that relate an output current of the solar power source to an output voltage of the solar power source, and that relate the output voltage of the solar power source to the output power of the solar power source.

In one or more embodiments, using the measured VOC and the measured ISC to determine the estimated VMPP includes fitting the measured VOC and the measured ISC to predefined curves that relate an output current of the solar power source to an output voltage of the solar power source, and that relate the output voltage of the solar power source to the output power of the solar power source.

In one or more embodiments, executing the perturb-and-observe algorithm beginning at the estimated VMPP to determine an actual VMPP for transferring the output power from the solar power source to the load includes controlling a buck and boost converter to convert an output voltage of the solar power source to an output voltage of the solar power converter that is supplied to the load.

According to one optional feature of these embodiments, controlling the buck and boost converter includes adjusting at least one of a duty cycle and a switching frequency of a switching device in the buck and boost converter to transfer the output power from the solar power source to the load at or approximately at the actual MPP when executing the perturb-and-observe algorithm.

According to another optional feature of these embodiments, executing the perturb-and-observe algorithm includes repeatedly measuring an output voltage of the solar power source and an output current of the solar power source while transferring the output power from the solar power source to the load.

Generally, in another aspect, an apparatus includes: an input port configured to receive an output voltage of a solar power source; an output port configured to be connected to a load; a short circuit configured to be selectably connected and disconnected across the input port; a current measurement device; a voltage measurement device; a transfer device configured to convert the output voltage of the solar power source to a load voltage at the load; and a controller configured to control the apparatus. The controller is configured to cause the apparatus to execute an algorithm comprising: measuring an open circuit output voltage (VOC) of the solar power source using the voltage measurement device; connecting the short circuit across the input port; determining a short circuit current (ISC) output by the solar power source while the short circuit is connected across the input port; removing the short circuit from across the input port; using the measured open circuit voltage (VOC) and the measured short circuit current (ISC) to determine an initial estimate of a voltage maximum power point (VMPP) for the solar power source corresponding to a maximum power point (MPP) for transferring power from the solar power source to the load; executing a perturb-and-observe algorithm beginning at the estimated VMPP to determine an actual VMPP for transferring the power from the solar power source to the load; and operating the transfer device at or approximately at the actual VMPP.

In one or more embodiments, the controller is further configured to cause the apparatus to repeat the measuring, applying, determining, removing, using, and executing steps to update the actual VMPP as environmental conditions change resulting in changes to the actual VMPP.

In one or more embodiments, the controller is further configured to cause the apparatus to periodically repeat the measuring, applying, determining, removing, using, and executing steps to periodically update the actual VMPP.

In one or more embodiments, the controller uses the measured VOC and the measured ISC to determine the estimated VMPP by solving parametric equations that relate an output current of the solar power source to the output voltage of the solar power source, and that relate the output voltage of the solar power source to the output power of the solar power source.

In one or more embodiments, the controller uses the measured VOC and the measured ISC to determine the estimated VMPP by fitting the measured VOC and the measured ISC to predefined curves that relate an output current of the solar power source to the output voltage of the solar power source, and that relate the output voltage of the solar power source to the output power of the solar power source.

In one or more embodiments, the transfer device includes a buck and boost converter.

According to one optional feature of these embodiments, the buck and boost converter includes at least one switching device, wherein the controller is configured to adjust at least one of a duty cycle and a switching frequency of a switching device in the buck and boost converter to cause the transfer device to transfer the power from the solar power source to the load at or approximately at the actual MPP when executing the perturb-and-observe algorithm.

According to another optional feature of these embodiments, the buck and boost converter is configured to operate in a boost conversion mode when the output voltage of solar power source received at the input port is less than the load voltage, and to operate in a buck conversion mode when the output voltage of solar power source received at the input port is greater than the load voltage.

In one or more embodiments, the apparatus includes the solar power source. According to one optional feature of these embodiments, the apparatus further includes the load, wherein the load includes at least one of a battery and a light source.

In one or more embodiments, executing the perturb-and-observe algorithm includes repeatedly measuring the output voltage of the solar power source with the voltage measurement device and repeatedly measuring an output current of the solar power source with the current measurement device while the apparatus transfers the power from the solar power source to the load.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 380 nanometers to approximately 780 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum. It should also be understood that the term LED does not limit the physical and/or electrical package type of an LED. For example, as discussed above, an LED may refer to a single light emitting device having multiple dies that are configured to respectively emit different spectra of radiation.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

The term “controller” is used herein generally to describe various apparatus relating to the operation of a power converter. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. Such microcode may be stored in a memory device (e.g., a static memory device) associated with the processor. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs). A controller may also include one or more associated devices such as drivers, analog-to-digital converters (ADCs), comparators, etc.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

As used herein, the word “approximately” shall mean within ±2 percent. As used herein, when a first value is said to be “about” a second value, it shall mean that the first value is within ±10 percent of the second value.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates an example arrangement of a solar power system.

FIG. 2 illustrates example performance curves of a solar power source.

FIG. 3 is functional block diagram of an example embodiment of a solar power converter.

FIG. 4 is a flowchart illustrating an example embodiment of a method of operating a solar power converter.

FIG. 5 is a flowchart illustrating an example embodiment of a perturb-and-observe algorithm that may be employed in the method illustrated in FIG. 4.

### DETAILED DESCRIPTION

As discussed above, in general the output power from a solar power source has a characteristic curve wherein the output power reaches a maximum power, defined herein as the Maximum Power Point (MPP), at a certain output voltage, defined herein as the Voltage Maximum Power Point (VMPP). Transferring power from the solar power source at any other point than the MPP will be less efficient than operating at the MPP.

Therefore, the present inventor has recognized and appreciated that it would be beneficial to provide a method and apparatus which is capable of transferring power from a solar power source to a load at or approximately at the maximum power point. It would further be beneficial to provide such a method and apparatus which can relatively rapidly and accurately converge on the maximum power point without employing a complicated algorithm.

In view of the foregoing, various embodiments and implementations of the present invention are directed to a method and apparatus for transferring power from a solar power source to a load at or near the maximum power point of the solar power source.

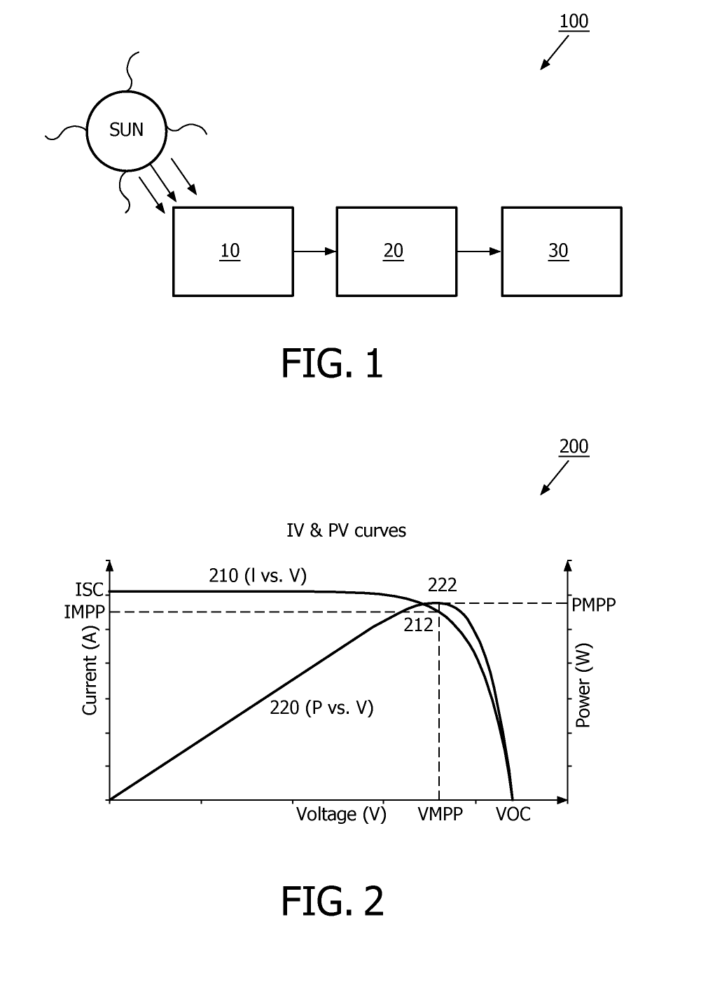

FIG. 1 illustrates an example arrangement of a solar power system 100. Solar power system 100 includes a solar power source 10, a solar power converter 20, and load 30. Solar power source 10 receives solar energy from a light source, typically the Sun, and in response thereto produces an output voltage and output current which together define an output power. In some embodiments, solar power source 10 includes one or more solar cells, including for example one or arrays of solar cells such as one or more solar panels. A solar cell, often referred to as a photovoltaic cell or photoelectric cell, is typically a solid state electrical device that converts the energy of light directly into electricity by the photovoltaic effect.

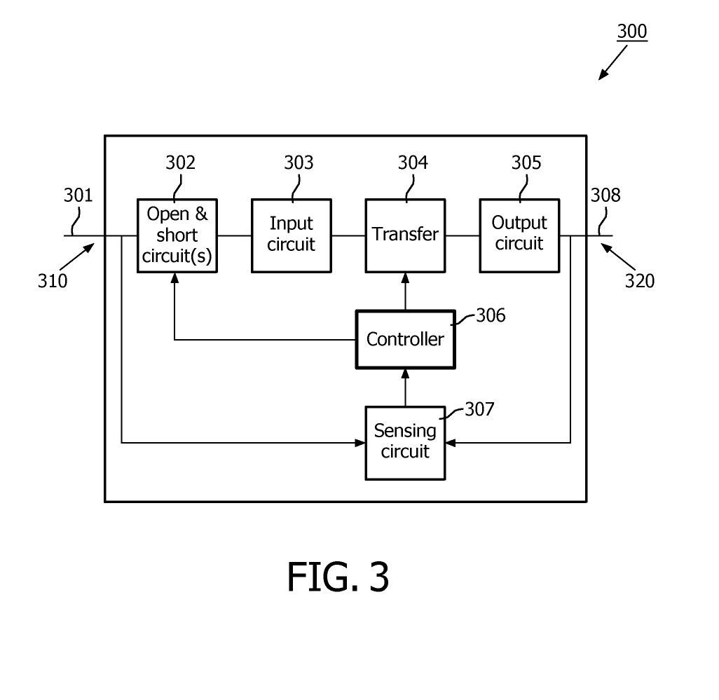

Solar power converter 20 controls the transfer of the output power from solar power source 10 to load 30. An example embodiment of solar power converter 20 will be described in greater detail below, particularly with respect to FIGS. 3-5.

In some embodiments, load 30 includes a battery system that includes one or more batteries which may be charged by power provided from solar power source 10 via solar power converter 20. In some embodiments, load 30 may additionally or alternatively include one or more light sources alternatively or additionally to a battery system. Such light sources may comprise one or more solid state light source such as a light emitting diode (LED)-based light sources.

As explained above, in general the output power from solar power source 10 has a characteristic curve wherein the output power reaches a maximum power, defined herein as the Maximum Power Point (MPP), at a certain output voltage, defined herein as the Voltage Maximum Power Point (VMPP).

FIG. 2 illustrates example performance curves 200 of a solar power source such as solar power source 10 in solar power system 100. In particular, FIG. 2 illustrates curve 210 which plots the output current (I) of solar power source 10 as a function of the output voltage (V) (i.e., I vs. V), and curve 220 which plots the output power (P) of solar power source as a function of the output voltage (V) (i.e., P vs. V). Here the output power P is understood to be a product of the output voltage V and the output current I: P=V*I. As shown in FIG. 2, the short circuit current which occurs when the output voltage is zero is labeled ISC, and the open circuit voltage which occurs when the output current is zero is labeled VOC.

As illustrated in FIG. 2, curve 220 exhibits a maximum at point 222 which is referred to herein as the Maximum Power Point (MPP). This is the operating point, at which solar power source 10 outputs the maximum output power, referred to herein as Power Maximum Power Point (PMPP), and therefore all other things being equal represents the most efficient operating point for solar power system 100. FIG. 2 also shows the Voltage Maximum Power Point (VMPP) which is the value of the output voltage V which corresponds to the Maximum Power Point. FIG. 2 also shows that the output power is zero at both the short circuit current point ISC (V=0) and the open circuit voltage point VOC (I=0).

As also illustrated in FIG. 2, curve 210 has a point 212 where the output voltage V equals VMPP, at which point the output current I equals the Current Maximum Power Point (IMPP) which is the value of the output current I which corresponds to the Maximum Power Point. That is: PMPP=VMPP*IMPP.

As explained above, in general the MPP for solar power source 10 will vary from one device to another. Furthermore, the MPP for a given solar power source 10 will vary with time, in particular due to changing environmental conditions, and specifically as the amount of solar energy received by the solar power source changes due to changes in the amount of sunlight that is received.

Accordingly, it is desirable for solar power converter 20 to locate and track the MPP of solar power converter 10 and to control the transfer of the output power from solar power converter 20 to load 30 to operate at the MPP. This is referred to herein as Maximum Power Point Tracking (MPPT).

A number of different approaches have been considered for controlling a solar power converter. Among these approaches are: (1) a constant voltage control technique (CVT); (2) a perturb & observe (P&O) technique; and (3) an incremental conductance technique (IncCond). Various combinations of these techniques have also been considered. Each of these techniques exhibits certain advantages and disadvantages as shown in Table 1 below.

TABLE 1

| MPPT | | |
|---|---|---|
| method | Advantage | Disadvantage |
| CVT | 1. Simple control and | 1. Not good in MPP accuracy - |
| | implementation. | it all depends on the given |
| | 2. Good stability because | fixed voltage. |
| | there are no big oscillations | 2. Cannot track MPP under |
| | of solar panel voltage. | rapidly changing atmospheric |
| | | conditions |
| P&O | 1. Simple feedback | 1. Slow response speed for |
| | structure. | tracking the MPP. |
| | 2. Easy to implement in | 2. Difficult to track MPP under |
| | hardware and software. | rapidly changing atmospheric |
| | | conditions. |
| IncCond | 1. Fast response speed to | 1. Complicated algorithm, high |
| | track the MPP. | requirement to control system. |
| | 2. Independent of solar | 2. The initial parameters of the |
| | panel characteristics. | controlled voltage greatly affect |
| | 3. No power loss due to | system efficiency. If not |
| | oscillations. | properly set, a large power loss |
| | | occurs. |

The present inventor has conceived of a MPPT method which is a modified P&O method and which can relatively rapidly and accurately converge on the MPP without employing a complicated algorithm. The MPPT method as described in greater detail below with respect to FIGS. 3-5 determines the short circuit current ISC and the open circuit voltage VOC, and makes initial estimates of MPP and VMPP from ISC and VOC. The MMPT method then uses these initial estimates as an entry point into a P&O algorithm that will in general be relatively close to the actual MPP and actual VMPP, respectively. This estimate allows the solar power converter to relatively rapidly and accurately converge on the actual MPP and VMPP without employing a complicated algorithm.

FIG. 3 is functional block diagram of an example embodiment of a solar power converter 300. Solar power converter 300 includes open and short circuit(s) 302, an input circuit 303, a transfer circuit 304, an output circuit 305, a controller 306, and a sensing circuit 307. Solar power converter 300 also includes an input port 310 and an output port 320. Solar power converter 300 may be one embodiment of solar power converter 20 of FIG. 1.

Input port 310 may be connected to the output of a solar power source (e.g., solar power source 10) to receive an output voltage 301, output current, and output power from the solar power source.

Open and short circuit(s) 302 are configured to selectively provide an open circuit across input port 310, and alternatively to selectively provide a short circuit across input port 310, for example in response to one or more control signals from controller 306. Since input port 310 may be connected to the output of a solar power source, it follows that open and short circuit(s) 302 are configured to selectively provide an open circuit across the output of the solar power source, and alternatively to selectively provide a short circuit across the output of the solar power source. it should be understood that the short circuit may not be an ideal or perfect short circuit, but instead may comprise a very low impedance by means of which the short circuit current ISC may be sampled or measured. Similarly, it should be understood that the open circuit may not be an ideal or perfect open circuit, but instead may comprise a very high impedance by means of which the open circuit voltage VOC may be sampled or measured. In some embodiments, the short circuit may comprise a switching device connected across input port 310 which may be opened in normal operation of solar power converter 300, and closed when it is desired to provide the short circuit. In some embodiments, the open circuit may be provided by a switch in series with one terminal of input port 310 which may be closed in normal operation of solar power converter 300, and open when it is desired to provide the open circuit.

Input circuit 303, transfer circuit 304, and output circuit 305 transfer power received via input port 310 from a solar power source to a load (e.g., load 30) which may be connected to output port 320. The load may comprise a battery system that includes one or more batteries which may be charged by power provided from the solar power source via solar power converter 300. In some embodiments, the load may additionally or alternatively include one or more light sources alternatively or additionally to a battery system. Such light sources may comprise one or more solid state light source such as a light emitting diode (LED)-based light sources.

In some embodiments, input circuit 303, transfer circuit 304, and output circuit 305 may together comprise a DC-to-DC power converter. In particular, input circuit 303, transfer circuit 304, and output circuit 305 may together comprise a buck and boost converter capable of operating in a boost conversion mode when the input voltage 301 at input port 310 is less than the output voltage, or load voltage, 308 at output port 320, and of operating in a buck conversion mode when the input voltage 301 at input port 310 is greater than the output voltage 308 at output port 320, and of operating in a direct conversion mode when the input voltage 301 at input port 310 is about the same as the output voltage 308 at output port 320. An example of such a power converter is described in U.S. patent application Serial No. 61/583,645, filed in the names of Zhiquan Chen and Jian Lin Xu, et al., the teachings of which are incorporated herein by reference.

Sensing circuit 307 is configured to sense characteristics of the input and output signals of solar power converter 300 to facilitate control of solar power converter 300 by controller 306. Beneficially, sensing circuit includes: a first current measurement device configured to measure the input current provided to input port 310 from a solar power source; a first voltage measurement device configured to measure the input voltage 301 provided to input port 310 from the solar power source; a second current measurement device configured to measure the output current provided to the load via output port 320; and a second voltage measurement device configured to measure the output voltage 308 provided to the load via output port 320.

Controller 306 is configured to control the operations of solar power converter. In particular, controller 306 controls open and short circuit(s) 302 and a transfer circuit 304 to transfer power from a solar power source connected to input port 310 to a load connected to output port 320.

Controller 306 may be implemented in numerous ways (e.g., such as with dedicated hardware) to perform various functions discussed herein. In some embodiments, controller 306 may employ one or more microprocessors that may be programmed using software (e.g., microcode) to perform various functions discussed herein. Such microcode may be stored in a memory device (e.g., a static memory device) associated with the processor. In other embodiments, controller 306 may be implemented without employing a processor, and also may be implemented as a combination of dedicated hardware to perform some functions and a processor (e.g., one or more programmed microprocessors and associated circuitry) to perform other functions. Examples of controller components that may be employed in various embodiments include, but are not limited to, conventional microprocessors, application specific integrated circuits (ASICs), and field-programmable gate arrays (FPGAs). Controller 306 may also include one or more associated devices such as drivers, analog-to-digital converters (ADCs), comparators, etc.

To better illustrate an example operation of solar power controller 300, in the discussion to follow it is assumed that the load connected to output port 320 is a load such as a battery system wherein solar power controller 300 needs to provide a specific output voltage 308 that is matched to the load. Furthermore, it is desired to operate solar power controller 300 with an input voltage (output voltage of the solar power source) 301 that is at or near the voltage maximum power point (VMPP) of the solar power source. In general, the VMPP of the solar power source will not be the same as the output voltage 308 for the load. Furthermore, as discussed above the VMPP will vary from solar power source to solar power source, and furthermore the VMPP for a given solar power source vary with time according to different environmental conditions (e.g., the amount of sunlight present). Therefore, solar power controller 300 needs to convert the input voltage 301 received from the solar power converter to the particular output voltage 308 of the load. Toward this end, it will further be assumed that transfer circuit 304 includes a buck and boost converter which operates under control of controller 306 to convert the input voltage 301 at the input port 310 to a desired output voltage 308 at output port 320. In that case, the buck and boost converter of transfer circuit 304 includes one or more switching devices which are switched on and off with a corresponding pulse width modulated (PWM) control signal under control of controller 306. The frequency and/or duty cycle(s) of the PWM control signal(s) may be adjusted by controller 306 to cause solar power converter 300 to operate with a desired input voltage 301 and output voltage 308.

As discussed above, it is desired for solar power converter 300 to transfer power from the solar power source at or near its Maximum Power Point (MPP). Accordingly, controller 306 executes an algorithm to find the MPP of the solar power source and to track the MPP as it changes. Beneficially, controller 306 executes a perturb-and-observe (P&O) algorithm to track the MPP. That is, controller 306 causes solar power converter 300 to make a small change in it operating point (“perturb” step), and then to measure (“observe”) the impact of each of those changes on the output power of the solar power source. If the change causes the output power of the solar power source to increase, then controller 306 causes solar power converter 300 to make another small change in the same direction as the previous change. On the other hand, if the change causes the output power of the solar power source to decrease, then controller 306 causes solar power converter 300 to make another small change in the opposite direction as the previous change. This can be seen to a form of a closed loop feedback system.

However, alone this P&O algorithm can suffer from a slow response speed for locking in on the MPP, and it can be difficult to track the MPP under rapidly changing atmospheric conditions.

Accordingly, beneficially, controller 306 executes an algorithm to estimate the MPP for the solar power source, and then performs the perturb-and-observe algorithm beginning at an estimated MPP, MPP_{EST}, to determine an actual MPP for transferring the output power from the solar power source to the load. Beneficially, the controller 306 controls solar power converter 300 to transfer power from the solar power source at the MPP by causing the input voltage of solar power converter 300 (output voltage of the solar power source) to be VMPP. In that case, controller 306 may execute an algorithm to estimate the VMPP (VMPP_{EST}) for the solar power source, and then performs the perturb-and-observe algorithm beginning at the estimated VMPP to determine the actual VMPP for transferring the output power from the solar power source to the load. Controller 306 may then cause solar power converter 300 to operate at or approximately at the actual VMPP.

Beneficially, controller 306 makes its initial estimate(s) of PMPP (PMPP_{EST}) and/or VMPP (VMPP_{EST}) by measuring the short circuit current ISC and measuring the open circuit voltage VOC and estimating the MPP from ISC and VOC based on the relationships illustrated in FIG. 2 above.

In some embodiments, a curve fitting approach may be employed using the general curves shown in FIG. 2 to estimate VMPP, IMPP, and PMPP from VOC and ISC. Curve fitting algorithms are generally known.

In other embodiments, the curves shown in FIG. 2 are mapped to parametric equations using the variables ISC and VOC, and VMPP_{EST}, IMPP_{EST}, and PMPP_{EST} are determined from these parametric equations.

In some embodiments, the estimated value of VMPP (VMPP_{EST}) may be about equal to the actual VMPP (i.e., within ±10%). In some embodiments, the estimated value of VMPP (VMPP_{EST}) may be approximately equal to the actual VMPP (i.e., within ±2%).

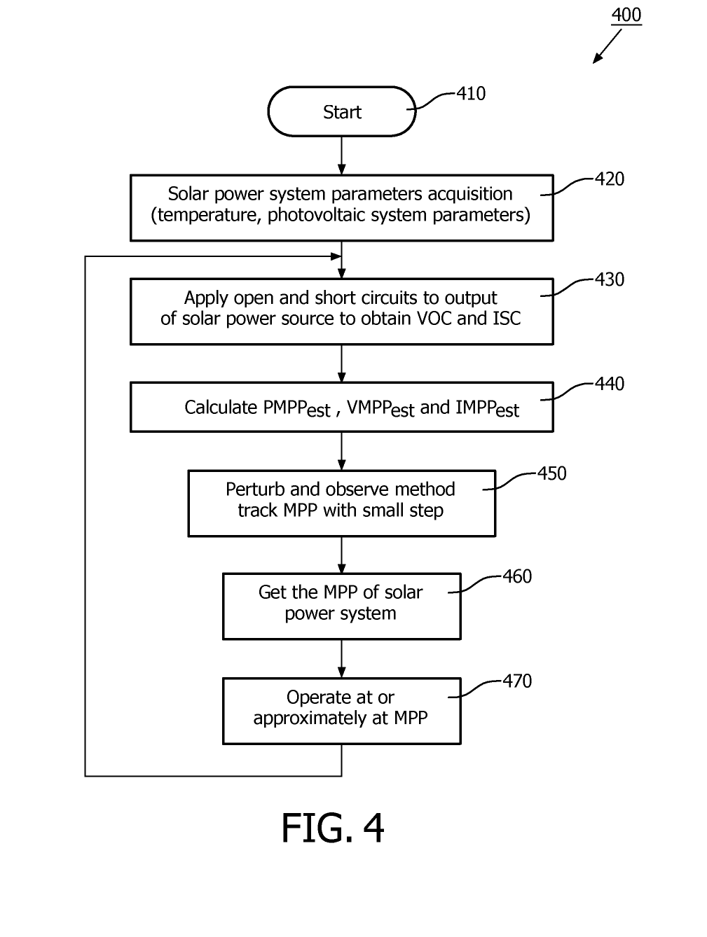

FIG. 4 is a flowchart illustrating an example embodiment of a method 400 of operating a solar power converter, such as solar power converter 300.

In a step 410, an algorithm for controlling solar power converter 300 starts. In a step 420, various parameters of the solar power system are obtained. These parameters may include an ambient temperature and various parameters pertaining to the photovoltaic cells in the solar power source. In some embodiments, these parameters may be used to establish the general curves shown in FIG. 2, or to establish parametric equations that relate VMPP, IMPP, and PMPP to ISC and VOC.

In a step 430, controller 306 controls solar power converter 300 to obtain the short circuit current ISC of the solar power source and the open circuit output voltage VOC of the solar power source. Beneficially, controller 306 sends one or more control signals to open and short circuit(s) 302 to provide an open circuit across input port 310, and then a voltage measurement device in sensing circuit 307 measures the open circuit voltage across input port 310 (i.e., VOC) and provides that data to controller 307 (for example, via an ADC in controller 307). Then controller 306 sends one or more control signals to open and short circuit(s) 302 to provide a short circuit across input port 310, and then a current measurement device in sensing circuit 307 measures the short circuit current through input port 310 (i.e., ISC) and provides that data to controller 307 (for example, via an ADC in controller 307). Of course in some embodiments, the order of measuring VOC and ISC may be reversed such that ISC is measured before VOC. Also, it should be understood that the short circuit may not be an ideal or perfect short circuit, but instead may comprise a very low impedance by means of which the short circuit current ISC may be sampled or measured. Similarly, it should be understood that the open circuit may not be an ideal or perfect open circuit, but instead may comprise a very high impedance by means of which the open circuit voltage VOC may be sampled or measured.

Next, in a step 440 controller 306 calculates an initial estimate of VMPP (VMPP_{EST}) and, beneficially, also an initial estimate of PMPP (PMPP_{EST}) and an initial estimate of IMPP (IMPP_{EST}).

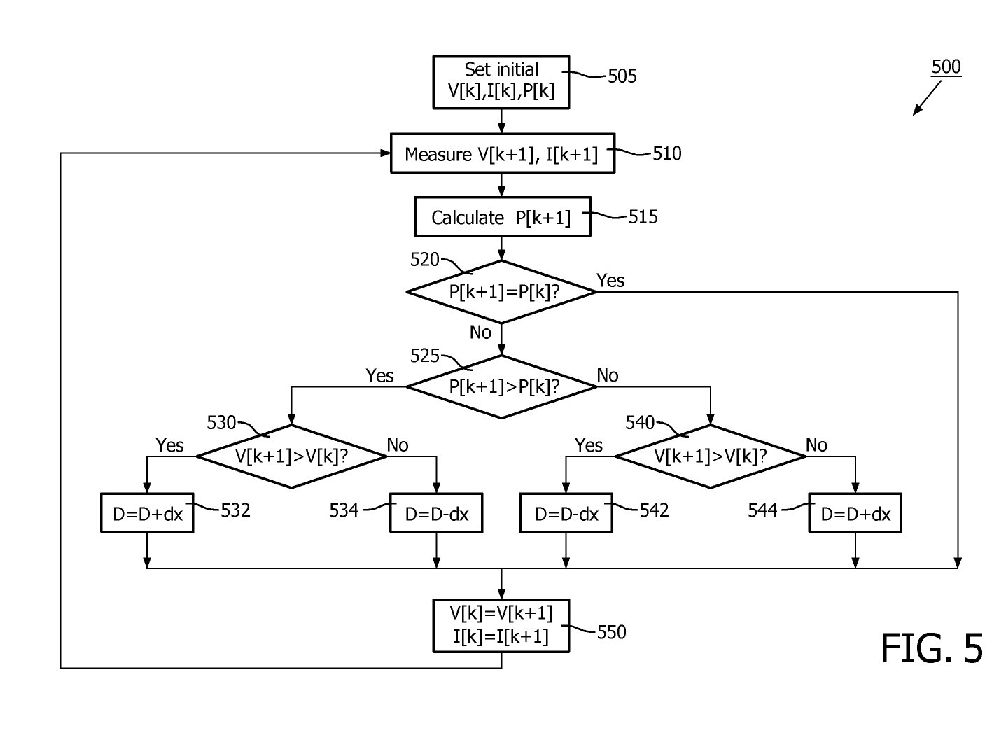

Subsequently, in a step 450 controller causes solar power converter to execute a P&O algorithm beginning at the estimated value VMPP_{EST} to determine an actual VMPP for transferring the output power from the solar power source to the load. Further details of an example embodiment of a P&O algorithm will be described below with respect to FIG. 5. In a step 460, as an output of the P&O algorithm, controller 306 obtains the actual MPP, and the actual VMPP, for the solar power source connected to the input port 310.

In a step 470, controller 306 causes solar power converter 300 to operate at or approximately at the MPP. For example, controller 306 may adjust at least one of a frequency and a duty cycle of one or more PWM control signals provided to one or more switching devices in transfer circuit 304 so as to cause the input voltage to solar power converter 300 (output voltage of the solar power source) to equal or approximately equal VMPP for a given output voltage 308 for a load connected to output port 320.

In some embodiments, periodically the process returns to step 430 to remeasure ISC and VOC and calculate a new estimated MPP and VMPP, and then repeats steps 440, 450, 460 and 470. In other embodiments, controller 306 may determine that environmental changes have occurred which trigger it to return to step 430 to remeasure ISC and VOC and calculate a new estimated MPP and VMPP, and then repeats steps 440, 450, 460 and 470.

FIG. 5 is a flowchart illustrating an example embodiment of a perturb-and-observe (P&O) algorithm 500 that may be employed in the method illustrated in FIG. 4. In particular, P&O algorithm 500 may correspond to step 450 in FIG. 4.

In a first step 505, the input voltage, input current, and input power of solar power converter 300 at input port 310 are set to initial values V(k), I(k), and P(k) respectively. It is understood that the input voltage 301, input current, and input power of solar power converter 300 correspond respectively to the output voltage 301, output current, and output power of a solar power source connected to input port 310.

Beneficially, the P&O algorithm is begun with V(k)=VMPP_{EST},I(k)=IMPP_{EST}, and P(k) PMPP_{EST}. As described above, controller 305 may attempt to control solar power converter 300 to set the input voltage, input current, and input power of solar power converter 300 to be VMPP_{EST}, IMPP_{EST}, and PMPP_{EST}, respectively, by means of setting the frequency and/or duty cycle of one or more PWM control signals supplied to one or more switching devices in transfer circuit 304. The initial settings may be determined using the values of the output voltage 308 and output current at output port 320, which may be measured and supplied to controller 306 by measurement devices in sensing circuit 307.

In a step 510, at some time after setting V(k) =VMPP_{EST}, I(k)=IMMP_{EST}, and P(k) PMPP_{EST}, the actual input voltage V(k+1) and the actual input current 1(k+1) are measured. In particular, controller 306 may receive measurements of the input current and input voltage from measurement devices included in sensing circuit 307.

In a step 515, controller 306 calculates the actual input power P(k+1) from V(k+1) and I(k+1). In a step 520, the measured power P(k+1) is compared to the initial estimated PMPP (i.e., P(k)) to determine whether the calculated input power equals the initial estimated PMPP. If it is equal, then the process proceeds to step 550 as described below. If not, then the process proceeds to step 525.

In a step 525, it is determined whether the calculated input power P(k+1) is greater than or less than the initial estimated PMPP (i.e., P(k)). If the calculated input power P(k+1) is greater than the initial estimated PMPP (i.e., P(k)), then the process proceeds to step 530.

In a step 530, the measured input voltage V(k+1) is compared to the initial estimated VMPP (i.e., V(k)) to determine whether the measured input voltage V(k+1) is greater than the initial estimated VMPP (i.e., V(k)). If so, then the process proceeds to step 532.

In step 532, the duty cycle of the PWM signal(s) supplied by controller 306 to transfer circuit 304 is increased. That is, the process 500 reaches step 532 when the input power has been increased while at the same time the input voltage has increased. In that case, it is clear that an increase in the input voltage has resulted in an increase in the input power. So in step 532 the process further increases the input voltage by increasing the duty cycle D by a relatively small amount dx (e.g., a couple of percent or less) so it may be observed whether this will lead to a further increase in the input power.

Meanwhile, if it is determined in step 530 that the measured input voltage V(k+1) is not greater than the initial estimated VMPP (i.e., V(k)), then the process proceeds to step 534. In step 534, the duty cycle of the PWM signal(s) supplied by controller 306 to transfer circuit 304 is decreased. That is, the process 500 reaches step 534 when the input power has been increased while at the same time the input voltage has decreased. In that case, it is clear that a decrease in the input voltage has resulted in an increase in the input power. So in step 534 the process further decreases the input voltage by decreasing the duty cycle D by a relatively small amount dx (e.g., a couple of percent or less) so it may be observed whether this will lead to a further increase in the input power.

If it is determined in step 525 that the calculated input power P(k+1) is less than the initial estimated PMPP (i.e., P(k)), then the process proceeds to step 540. In a step 540, the measured input voltage V(k+1) is compared to the initial estimated VMPP (i.e., V(k)) to determine whether the measured input voltage V(k+1) is greater than the initial estimated VMPP (i.e., V(k)). If so, then the process proceeds to step 542, in which the duty cycle of the PWM signal(s) supplied by controller 306 to transfer circuit 304 is decreased. That is, the process 500 reaches step 542 when the input power has been decreased while at the same time the input voltage has increased. In that case, it is clear that an increase in the input voltage has resulted in a decrease in the input power. So in step 542 the process decreases the input voltage by decreasing the duty cycle D by a relatively small amount dx (e.g., a couple of percent or less) so it may be observed whether this will lead to an increase in the input power.

Meanwhile, if it is determined in step 540 that the measured input voltage V(k+1) is not greater than the initial estimated VMPP (i.e., V(k)), then the process proceeds to step 544. In step 544, the duty cycle of the PWM signal(s) supplied by controller 306 to transfer circuit 304 is increased. That is, the process 500 reaches step 544 when the input power has been decreased while at the same time the input voltage has decreased. In that case, it is clear that a decrease in the input voltage has resulted in a decrease in the input power. So in step 544 the process increases the input voltage by increasing the duty cycle D by a relatively small amount dx (e.g., a couple of percent or less) so it may be observed whether this will lead to an increase in the input power.

After any of the steps 532, 534, 542 or 544, the process proceeds to step 540 wherein the “old” voltage and current values V(k) and I(k) are updated or replaced with the most recent measured voltage and current values V(k+1) and I(k+1), and the “old” power value P(k) is updated or replaced with the most recent calculated power P(k+1). Then the process returns to step 510 where new voltage and current values V(k+1) and I(k+1) are measured.

From step 510, process 500 repeats so as to continually attempt to maximize the input power received at input port 310 corresponding to the output power of the solar power source so as to cause solar power converter 300 to operate at or approximately at the actual VMPP and PMPP.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

Also, reference numerals appearing in the claims in parentheses, if any, are provided merely for convenience and should not be construed as limiting the claims in any way.

1. A method of controlling a solar power converter connected to receive output power from a solar power source the method comprising:
measuring an open circuit voltage of the solar power source;
applying a short circuit across an output of the solar power source;
determining a short circuit current output by the solar power source while the short circuit is applied across the output of the solar power source;
removing the short circuit from across the output of the solar power source;
using the measured open circuit voltage and the measured short circuit current to determine an estimate of a voltage maximum power point for the solar power source corresponding to a maximum power point for transferring the output power from the solar power source to a load;
executing a perturb-and-observe algorithm beginning at the estimated VMPP to determine an actual VMPP for transferring the output power from the solar power source to the load; and
operating the solar power converter at or approximately at the actual VMPP.

2. The method of claim 1, further comprising repeating the measuring, applying, determining, removing, using, and executing steps to update the actual VMPP as environmental conditions change resulting in changes to the actual VMPP.

3. The method of claim 1, further comprising periodically repeating the measuring, applying, determining, removing, using, and executing steps to periodically update the actual VMPP.

4. The method of claim 1, wherein using the measured VOC and the measured ISC to determine the estimated VMPP comprises solving parametric equations that relate an output current of the solar power source to an output voltage of the solar power source, and that relate the output voltage of the solar power source to the output power of the solar power source.

5. The method of claim 1, wherein using the measured VOC and the measured ISC to determine the estimated VMPP comprises fitting the measured VOC and the measured ISC to predefined curves that relate an output current of the solar power source to an output voltage of the solar power source, and that relate the output voltage of the solar power source to the output power of the solar power source.

6. The method of claim 1, wherein executing the perturb-and-observe algorithm beginning at the estimated VMPP to determine an actual VMPP for transferring the output power from the solar power source to the load comprises controlling a buck and boost converter to convert an output voltage of the solar power source to an output voltage of the solar power converter that is supplied to the load.

7. The method of claim 6, wherein controlling the buck and boost converter comprises adjusting at least one of a duty cycle and a switching frequency of a switching device in the buck and boost converter to transfer the output power from the solar power source to the load at or approximately at the actual MPP when executing the perturb-and-observe algorithm.

8. The method of claim 6, wherein executing the perturb-and-observe algorithm comprises repeatedly measuring an output voltage of the solar power source and an output current of the solar power source while transferring the output power from the solar power source to the load.

9. An apparatus comprising:
an input port configured to receive an output voltage of a solar power source
an output port configured to be connected to a load;
a short circuit configured to be selectably connected and disconnected across the input port;
a current measurement device;
a voltage measurement device;
a transfer device configured to convert the output voltage of the solar power source to a load voltage at the load; and
a controller configured to cause the apparatus to execute an algorithm comprising:
measuring an open circuit output voltage of the solar power source using the voltage measurement device;
connecting the short circuit across the input port;
determining a short circuit current output by the solar power source while the short circuit is connected across the input port;
removing the short circuit from across the input port;
using the measured open circuit voltage and the measured short circuit current to determine an initial estimate of a voltage maximum power point for the solar power source corresponding to a maximum power point for transferring power from the solar power source to the load;
executing a perturb-and-observe algorithm beginning at the estimated VMPP to determine an actual VMPP for transferring the power from the solar power source to the load; and
operating the transfer device at or approximately at the actual VMPP.

10. The apparatus of claim 9, wherein the controller is further configured to cause the apparatus to repeat the measuring, applying, determining, removing, using, and executing steps to update the actual VMPP as environmental conditions change resulting in changes to the actual VMPP.

11. The apparatus of claim 9, wherein the controller is further configured to cause the apparatus to periodically repeat the measuring, applying, determining, removing, using, and executing steps to periodically update the actual VMPP.

12. The apparatus of claim 9, wherein the controller uses the measured VOC and the measured ISC to determine the estimated VMPP by solving parametric equations that relate an output current of the solar power source to the output voltage of the solar power source, and that relate the output voltage of the solar power source to the output power of the solar power source.

13. The apparatus of claim 9, wherein the controller uses the measured VOC and the measured ISC to determine the estimated VMPP by fitting the measured VOC and the measured ISC to predefined curves that relate an output current of the solar power source to the output voltage of the solar power source, and that relate the output voltage of the solar power source to the output power of the solar power source.

14. The apparatus of claim 9, wherein the transfer device comprises a buck and boost converter.

15. The apparatus of claim 14, wherein the buck and boost converter includes at least one switching device, and wherein the controller is configured to adjust at least one of a duty cycle and a switching frequency of a switching device in the buck and boost converter to cause the transfer device to transfer the power from the solar power source to the load at or approximately at the actual MPP when executing the perturb-and-observe algorithm.

16. The apparatus of claim 14, wherein the buck and boost converter is configured to operate in a boost conversion mode when the output voltage of solar power source received at the input port is less than the load voltage, and to operate in a buck conversion mode when the output voltage of solar power source received at the input port is greater than the load voltage.

17. The apparatus of claim 9, further comprising the solar power source.

18. The apparatus of claim 17, further comprising the load wherein the load includes at least one of a battery and a light source.

19. The apparatus of claim 9, further comprising the load, wherein the load includes one or more batteries.

20. The apparatus of claim 9, wherein executing the perturb-and-observe algorithm comprises repeatedly measuring the output voltage of the solar power source with the voltage measurement device and repeatedly measuring an output current of the solar power source with the current measurement device while the apparatus transfers the power from the solar power source to the load.
